(19) United States
(12) Patent Application Publication
(10) Pub. No.: US 2011/0311812 A1
(43) Pub. Date: Dec. 22, 2011

(54) METHOD AND APPARATUS FOR WELDING WIRES

(76) Inventor: Dirk Haussmann, Barsinghausen (DE)

(21) Appl. No.: 13/254,803

(22) PCT Filed: Feb. 26, 2010
(86) PCT No.: PCT/DE2010/000216

§ 371 Date: Sep. 2, 2011

(30) Foreign Application Priority Data
Mar. 2, 2009 (DE) 1020090110372

(51) Int. Cl. D02G 3/00; B23K 26/14; B23K 26/20

(52) U.S. Cl. 428/373; 219/58; 219/56

(57) ABSTRACT

A method for welding wires (2) is provided, wherein at least two wires (2) are welded to each other by way of a laser source, wherein at least one wire (2) to be welded is subjected to an annealing process using a hot gas flow prior to the welding process, and/or at least the resulting welded joint is subjected to an annealing process using a hot gas flow during the welding process, and/or the resulting welded joint is subjected to an annealing process using a hot gas flow following the welding process.

The invention relates to a method and a device for the welding of, in particular thin, in particular carbon-containing, wires.

Various wire welding methods are known from the prior art, in which wires to be welded are welded by means of current feed and subsequently post-treated by means of a further current feed for temperature increase or in an annealing chamber, whereby the resulting welding point always protrudes as a thickening markedly beyond the cross section of the welded wires, however. All welding methods according to the prior art which function by means of current feed have the problem of a contact point (surface and condition of the contact point for initiating the current feed) which is less and less well defined as diameters become smaller, which leads to a high prevalence of imperfections. Furthermore, the thickening in the region of the welding point constitutes a problem, so that this point has to be levelled, mostly mechanically, for relevant applications, and if appropriate then a further annealing treatment step follows, in order to ensure sufficient tensile and bending loads, reference being made here for example to U.S. Pat. No. 6,311,684 B1.

In spite of the double subsequent annealing, the corresponding weldings often do not have sufficient mechanical tensile loading and bending loading strengths, the mechanical removal (of the welding burr) of the thickening in the region of the welding point and the energetically relatively unfavourable annealing in the furnace constituting a high time, energy and therefore cost factor.

The problem upon which the invention is based and the object thereof lies in reducing or avoiding the above-mentioned disadvantages at least to some extent, particularly with a view to also avoiding a mechanical removal of the thickening in the region of the welding point of the wires and multiple annealing at the same time, in order to thus provide a cost-effective, fast and reliable welding process for thin wires.

This object is achieved according to the invention by means of a method according to claim 1, a device according to claim 17, a wire according to claim 33 and a use according to claim 34.

The method according to the invention is a method for the welding of wires, particularly high-strength, that is to say for the most part high-carbon wires, i.e. wires, the diameters of which are generally no more than 0.5 mm, and the carbon content of which is greater than 10 per cent by weight, which method is characterised in that at least two wires are welded to one another by means of a laser source, wherein for example and in particular a pulsed solid-state laser comes into consideration as laser source, wherein before the welding, at least one wire to be welded is subjected to an annealing by means of a hot gas flow and/or during the welding at least the resulting welding point is subjected to an annealing by means of a hot gas flow and/or, subsequently thereto, the resulting welding point, which also appears as welding point (welding bead) and is designated as such, is subjected to an annealing process (an annealing) by means of a hot gas flow. In particular, the hot gas flow is orientated in a punctiform manner. In particular and for example, the hot gas flow has a temperature between +250° C. and +500° C.

In addition to an extreme simplification of the method process and a very large time saving, realising the annealing by means of a punctiform hot gas flow in particular brings the advantage that the welding zone affected is only subjected to the thermal treatment in a punctiform manner and thus the wire not affected by the welding does not experience a treatment which changes its properties.

Among other things, it is essential to the invention that by means of a laser source, the wires are welded to one another, as with the aid of such a homogeneous energy input independent of the wire diameter and with the aid of the mechanical process control components described below, a welding point forms, the spatial dimension of which does not extend substantially beyond the radial cross section of the wires to be welded, wherein advantages are connected with the application of a hot gas flow, preferably and for example when this is selected from the group of air, nitrogen and noble gas, as these substances have proven themselves well in practice, wherein it has furthermore been proven exceptionally advantageous in practice that the hot gas is applied to the welding point by means of a nozzle, so a targeted spatially narrowly delimited discharge of heat is enabled, so that the highest temperature advantageously prevails in the welding point during the annealing process, so that, seen from the welding point in the direction of the longitudinal axis of the wires, a continuous temperature decrease, which essentially ensures the achievement of the material properties outside of the annealing zone, can be detected.

In this manner, a method for welding wires is provided, which ensures a reliable and reproducible welding which makes a mechanical removal of the otherwise protruding welding burr from the prior art at the welding point superfluous, which leads to considerable time and money savings, and on the other hand by means of the special annealing by means of a hot gas flow and not, as is conventional in the prior art, by means of an annealing in a furnace or by means of temperature increase by means of current feed, recrystallisation processes take place in the metal structure of the welded wires in a controlled manner due to the temperature profile which is set, in order in this manner to generate or ensure an exceptionally high bending and tensile loadability.

It is furthermore advantageous if the welding of the wires is carried out under a protective gas, for example and in particular argon, in order either to avoid scaling or to achieve a high quality of the welding point.

Furthermore, it is advantageous if the protective gas is applied by means of the nozzle for the hot gas, that is to say the nozzle from which the hot gas emerges, in order in this manner to realise a simple construction in terms of apparatus.

It is furthermore advantageous if, during the welding, the maximum temperature of the wires to be welded to one another is located in the centre of the welding, in order in this manner to achieve a uniform temperature gradient profile towards both sides, in order later to provide an optimal basis for the annealing which ultimately expresses itself in high tensile load strengths and bending loadabilities.

It is in particular advantageous if the wires to be welded are guided in, in particular destructible, tubes, what are known as precision adjustment tubes, for adapting different wire diameters as well as for the marked improvement of the handling of the thin wires, particularly in the glass tube, by means of a guiding apparatus which, for its part realises the guiding together of the wires, the contact pressure and the feed during the welding process, as well as the travel limitation of the wires fusing into one another. The parameter-precise compliance with all forces and paths during the welding process enables a reproducible welding of the wires which corresponds to the wire in terms of radial breadth. The precision adjustment tubes used can advantageously be removed following the process by means of mechanical pressure, e.g. by means of pliers.

Due to the above statements, it is therefore advantageous in each case if even the wires to be welded are guided to one another by means of a guiding apparatus and subsequently welded, if, when guiding the wires to be welded, tubes enclosing these wires are used for mutually aligning the wires and if the tubes are glass tubes, glass ceramic tubes or ceramic tubes.

Furthermore, it is advantageous if the wires to be welded are moved towards one another by means of a spring force element before the welding with a force—pulling or pushing, applied by the force element, in order to provide a defined point to be welded.

According to the invention, the term “force element” is to be understood as meaning elements which can be set up in such a manner that they exert a force on an element which is acted upon, so that for example, also pneumatic or hydraulic cylinder elements or also magnetic elements are included, but classic spring elements are to be emphasized in particular.

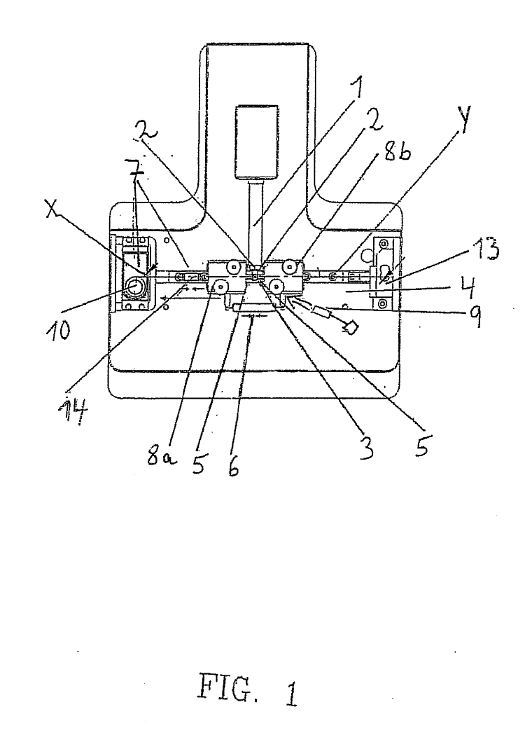

It is very particularly advantageous if, when welding the wires to be welded by means of a or the force element, the wires to be welded are moved—in a pulling or pushing manner—into one another, wherein the moving of the wires into one another is limited by means of a travel limitation element, for example and in particular by means of a cable or an adjusting screw, in such a manner that when welding the wires, the resulting welding point does not extend substantially beyond the radial cross section of the wires. This can for example and in particular be realised by means of a device illustrated in FIG. 1 and correspondingly described and the method steps associated therewith. In particular, by means of the pre-stressing, a defined contact pressure of the two wires to be welded is ensured, wherein at the moment of the welding by means of laser radiation, which generally only lasts a few thousandths of a second, both wires move into one another slightly by means of the material at the welding point which has become soft and can flow, so that, owing to the limiting of the distance, a corresponding thickening of the welding point (welding burr) is limited in a controlling and predetermining manner. Servomotors or similar adjustment elements would not be able to track the wires such that they flow into one another reproducibly and in a controlled manner within these short time periods, so non-reproducible and in general low quality welds would result.

It is advantageous and therefore proven in practice if the force element is an element from the group of pneumatic, hydraulic, magnetic or spring force element, as these ensure a particularly high reliability with regards to the reproducibility of the quality of the welding point, wherein fast servomotor force elements are entirely conceivable however, even if not quite in these dimensions.

It has proven advantageous in practice that the maximum diameter of the wires to be welded is 2 mm, which ultimately is probably due to heat dissipation and the rapid introduction of the energy by means of laser radiation more or less has upper limits with regards to a maximum diameter as a consequence.

Furthermore, it is advantageous if, following the annealing, a tensile loading test is carried out, in order to determine the respectively necessary minimum loadings with regards to tensile load strength directly following production, in order to detect any possible faults at this point in time already.

In this case, it is particularly advantageous if the welding of the wires, the annealing and the tensile loading test are carried out in one device, in order to save a complicated unclamping of the welded wires and a renewed clamping, which in turn substantially reduces work outlay, time and therefore costs.

The above-mentioned statements apply accordingly for a device according to the invention for carrying out the method according to the invention.

It is furthermore an important aspect of the present invention that the destructible precision adjustment tubes, produced preferably from glass, glass ceramic or ceramic, are used for carrying out the method according to the invention, as the combination of use of laser radiation by means of a laser source for the welding and the subsequent annealing by means of a hot gas flow can ultimately be carried out highly elegantly and reproducibly by means of these glass tubes which make sure of a reliable guiding and high stability of the wires when moved towards one another with increasing pressure onto the wire ends of the wires to be welded and at the same time can be removed by simple crushing for example by means of pliers following the welding.

In terms of production technology, it is furthermore of great advantage that, subsequently to the welding and annealing, a tensile loading test can be carried out in order to investigate the welding point in situ for its minimum requirements and, if appropriate, to rule out low quality.

The invention is explained in a non-limiting manner by the following examples.

In the figures:

FIG. 1 shows a schematic sketch in a plan view,

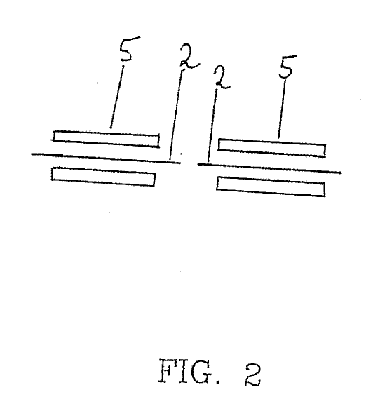

FIG. 2 shows a schematic cross-sectional view of a section from FIG. 1,

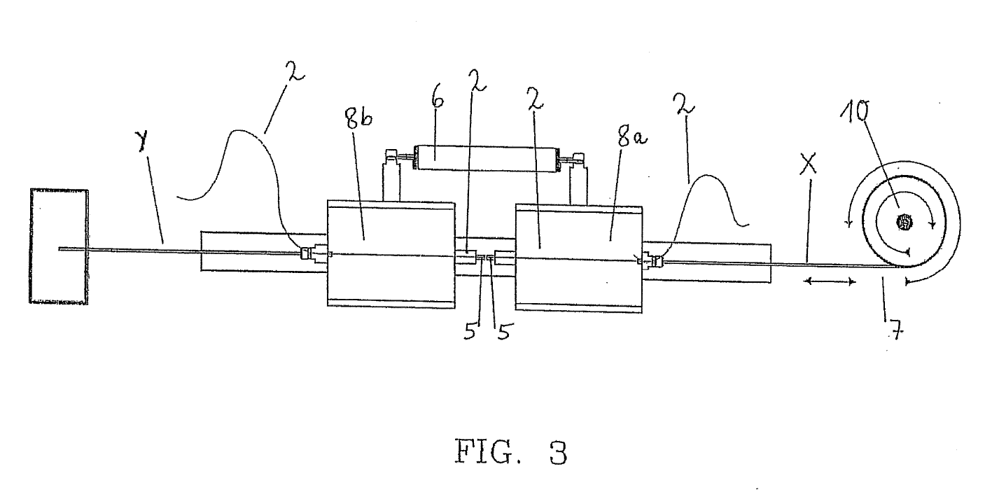

FIG. 3 shows a schematic cross-sectional view of the embodiment shown in FIG. 1,

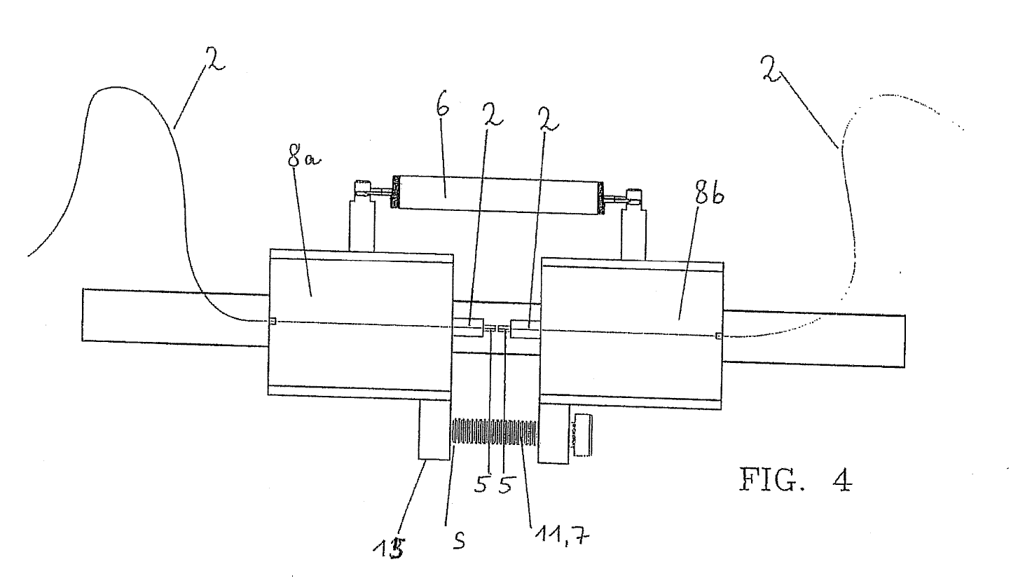

FIG. 4 shows a schematic cross-sectional view of a further embodiment, and

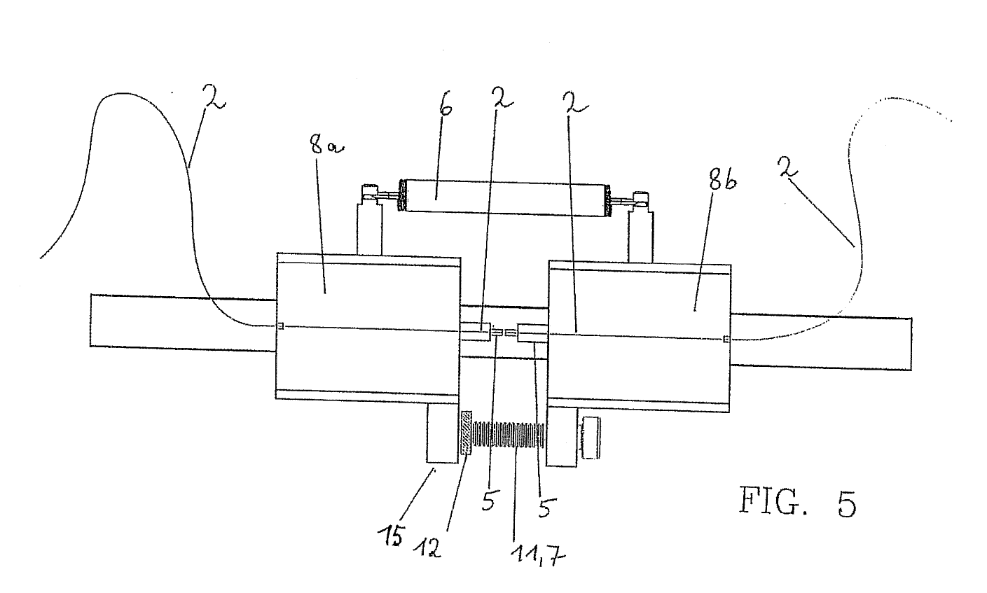

FIG. 5 shows a schematic cross-sectional view of a further embodiment.

In FIG. 1, a structure of a device according to the invention is to be seen from above.

The wires 2 to be welded are fixedly fastened in the centrally interior bore of one glass tube 5 in each case, in the movable support 8a or the fixed support 8b, respectively.

Support 8a is connected by means of a cable X to the servo-controlled roller 10. Support 8b is rigidly connected to the force pick-up sensor 13.

The spring 6 connects support 8a to support 8b under a prestress of a few Newtons. At this point in the process, the forces of the spring 6 are transmitted via the supports, the cable X and the roller 10 and the rigid connection Y, respectively, to the force pick-up sensor and then in each case to the housing.

By rotating the roller 10 in the clockwise direction, support 8a then moves towards support 8b, under the action of force from the spring 6 until the two welding wire ends touch.

With the touching of the wires, a displacement of the spring forces of spring 6 to the wires fixed in the supports 8a and 8b is produced.

Cable X and rigid connection Y do not absorb any more forces.

By means of a defined further rotation of the roller 10 in the clockwise direction, the cable X is released further by a defined distance. This distance later corresponds exactly to the distance by which the wires displace into one another during the welding process, pulled by the spring 6.

This distance determines the diameter of the welding burr, which ideally corresponds exactly to the wire diameter of the wire.

If the wires touch and the cable roller 10 has executed a defined further cable release, the two wires are welded to one another with a constant pressure and defined path by means of laser radiation.

After the application of the laser radiation and the welding of the two wires 2 which took place as a result, a welding point 3 has been created, which is then subjected to an annealing by means of a hot gas flow (4) by means of a nozzle 9 directed onto it, wherein the temperature of the hot gas flow is approx. +250° C. to +500° C., depending on material and diameter, and the hot gas is argon. The annealing takes place directly after the welding.

When annealing, it is to be ensured that the orientation of the nozzle 9 is such that the maximum temperature is located in the centre of the welding point 3, so that the temperature curve constantly sinks running outwards and in the case of final cooling following the annealing, a high tensile load and in particular bending loadability is set on account of the recrystallisation processes which have taken place due to the annealing.

Subsequently to the welding and the annealing, the welding point is subjected to a tensile loading test directly thereafter, that is to say following the cooling to room temperature, in order to investigate in situ the minimum requirements set. In this case, the roller 10 is rotated anticlockwise and, via the cable X, a spring 14 is tensioned and the now increasing force is guided via the fixed connection of the wires 2 in support 8a and 8b as well as the rigid connection Y to the force pick-up sensor 13. The entire force is conveyed via the welding point in the process. The force of the spring 6 is compensated via a zeroing of the measuring system before the measurement. By rotating the roller 10, the force can continuously be increased until the desired value.

If in the process, the welding point 3 is not destroyed, then the welding has been successful, so the two wires welded to one another—now the new joined wire—can be removed from the device subsequently to that.

It may be pointed out only for the sake of good order that the wires to be welded are fastened to respective clamping elements of the guiding apparatus 8 in a clamping manner at their distal ends with respect to the welding, for example and in particular by means of clamp jaws which are parts of the guiding apparatus 8.

Furthermore, it may be pointed out that following the welding and testing, the fragile glass tubes can simply be removed in a crushing/destructive manner for example and in particular by means of pliers.

In FIG. 2, how the two wires 2 to be welded are arranged in the respective glass tubes 5 in order then, moved together, to be welded can be seen again as a section and enlarged in comparison with FIG. 1.

In FIGS. 3 to 5, different exemplary embodiment principles are illustrated with regards to the travel limitation elements 7 with reference to the above explanations and statements for FIGS. 1 and 2, wherein the cable X is used as travel limitation element in FIG. 3, an adjusting screw 11 is used in FIG. 4 and in FIG. 5 an adjusting screw 11 and a [lacuna] between a counter bearing 15 and a spacer 12 is used as travel limitation element. In the embodiment in FIG. 3, reference may be made to the explanations for FIG. 1. With respect to FIG. 4, it can be discerned that a decidedly narrow gap S between a counter bearing 15 and the distal end of the adjusting screw 11 defines the delimited distance by means of corresponding setting of the adjusting screw 11 during welding, whilst this takes place in FIG. 5 by means of the spacer 12 which is removed before the welding.

It may be pointed out only for the sake of good order that instead of one spring pulling the supports 8a and 8b together, two springs pushing towards one another or other force elements can be used.

1. Method for the welding of wires, characterised in that at least two wires (2) are welded to one another by means of a laser source (1), wherein
a) before the welding, at least one wire (2) to be welded is subjected to an annealing by means of a hot gas flow (4), and/or
b) during the welding at least the resulting welding point (3) is subjected to an annealing by means of a hot gas flow (4), and/or
c) subsequently thereto, the resulting welding point (3) is subjected to an annealing by means of a hot gas flow (4).

2. Method according to claim 1, characterised in that the hot gas is one from the group air, nitrogen and noble gas.

3. Method according to any one of claims 1 to 2, characterised in that the hot gas is applied by means of a nozzle (9) to the welding point (3).

4. Method according to any one, of claims 1 to 3, characterised in that during the welding, the maximum temperature of the wires (2) to be welded to one another is located in the centre of the welding point (3).

5. Method according to any one of claims 1 to 4, characterised in that the wires (2) are carbon-containing wires.

6. Method according to any one of claims 1 to 5, characterised in that the welding of the wires is carried out under a protective gas.

7. Method according to claim 6, characterised in that the protective gas is applied by means of the nozzle (9) for the hot gas.

8. Method according to any one of claims 1 to 7, characterised in that the wires (2) to be welded are guided to one another by means of a guiding apparatus (8a, 8b) and subsequently welded.

9. Method according to claim 8, characterised in that when guiding the wires (2) to be welded, tubes (5) enclosing these wires (2) are used for mutually aligning the wires (2).

10. Method according to claim 9, characterised in that the tubes (5) are glass, ceramic or glass ceramic tubes.

11. Method according to any one of claims 1 to 10, characterised in that the maximum diameter of the wires (2) to be welded is 2 mm.

12. Method according to any one of claims 1 to 11, characterised in that following the annealing, a tensile loading test is carried out.

13. Method according to any one of claims 1 to 12, characterised in that the welding of the wires, the annealing and the tensile loading test are carried out in one device.

14. Method according to any one of claims 1 to 13, characterised in that the wires (2) to be welded are moved towards one another by means of a force element (6) before the welding with a force applied by the force element (6).

15. Method according to claim 14, characterised in that the force element is an element from the group of servomotor, pneumatic, hydraulic, magnetic or spring force element.

16. Method according to any one of claims 1 to 15, characterised in that when welding the wires (2) to be welded by means of a or the force element (6), the wires (2) to be welded are moved into one another, wherein the moving of the wires into one another is limited by means of a travel limitation element (7) in such a manner that when welding the wires (2), the resulting welding point (3) does not extend substantially beyond the radial cross section of the wires (2).

17. Device for the welding of wires, characterised in that the same is set up in such a manner that at least two wires (2) are welded to one another by means of a laser source (1), wherein
a) before the welding, at least one wire (2) to be welded is subjected to an annealing by means of a hot gas flow (4), and/or
b) during the welding at least the resulting welding point (3) is subjected to an annealing by means of a hot gas flow (4), and/or
c) subsequently thereto, the resulting welding point (3) is subjected to an annealing by means of a hot gas flow (4).

18. Device according to claim 17, characterised in that the hot gas (4) is one from the group air, nitrogen and noble gas.

19. Device according to any one of claims 17 to 18, characterised in that the same is set up in such a manner that the hot gas (4) is applied by means of a nozzle (9) to the welding point (3).

20. Device according to any one of claims 17 to 19, characterised in that the same is set up in such a manner that during the welding, the maximum temperature of the wires (2) to be welded to one another is located in the centre of the welding point (3).

21. Device according to any one of claims 17 to 20, characterised in that the same is set up in such a manner that the welding of the wires is carried out under a protective gas.

22. Device according to claim 21, characterised in that the same is set up in such a manner that the protective gas is applied by means of the nozzle (9) for the hot gas.

23. Device according to any one of claims 17 to 22, characterised in that the wires (2) are carbon-containing wires.

24. Device according to any one of claims 17 to 23, characterised in that the same is set up in such a manner that the wires (2) to be welded are guided to one another by means of a guiding apparatus (8a, 8b) and subsequently welded.

25. Device according to claim 24, characterised in that the same is set up in such a manner that when guiding the wires (2) to be welded, tubes (5) enclosing these wires (2) are used for mutually aligning the wires (2).

26. Device according to claim 25, characterised in that the tubes (5) are glass tubes.

27. Device according to any one of claims 17 to 26, characterised in that the maximum diameter of the wires (2) to be welded is 2 mm.

28. Device according to any one of claims 17 to 27, characterised in that the same is set up in such a manner that following the annealing, a tensile loading test is carried out.

29. Device according to any one of claims 17 to 28, characterised in that the same is set up in such a manner that the welding of the wires, the annealing and the tensile loading test are carried out in the device.

30. Device according to any one of claims 17 to 29, characterised in that the same is set up in such a manner that the wires (2) to be welded are moved towards one another by means of a force element (6) before the welding with a force applied by the force element (6).

31. Device according to claim 30, characterised in that the force element is an element from the group of servomotor, pneumatic, hydraulic, magnetic or spring force element.

32. Device according to any one of claims 17 to 31, characterised in that the same is set up in such a manner that when welding the wires (2) to be welded by means of a or the spring force element (6), the wires (2) to be welded are moved into one another, wherein the moving of the wires into one another is limited by means of a travel limitation element (7) in such a manner that when welding the wires (2), the resulting welding point (3) does not extend substantially beyond the radial cross section of the wires (2).

33. Wire produced by means of a method according to any one of claims 1 to 16 or by means of a device according to any one of claims 17 to 32.

34. Use of tubes for carrying out a method according to any one of claims 1 to 16.

35. Use according to claim 34, characterised in that the tubes are glass, glass ceramic or ceramic tubes.

36. Method according to any one of claims 1 to 16, characterised in that the annealing is carried out at a temperature of +250° C. to 500° C.

37. Device according to any one of claims 17 to 32, characterised in that the same is set up in such a manner that the annealing is carried out at a temperature of +250° C. to +500° C.
